(19) United States
(12) Patent Application Publication
(10) Pub. No.: US 2009/0203812 A1
(43) Pub. Date: Aug. 13, 2009

(54) Salts of Dehydroacetic Acid as an Antimicrobial for Plastics

(76) Inventors: Lei Rao, Highland Mills, NY (US); Joe Kimler, Trenton, NJ (US); Larry Kent Hall, Easton, PA (US)

Correspondence Address: HOFFMANN & BARON, LLP, 6900 JERICHO TURNPIKE, SYOSSET, NY, 11791, US

(21) Appl. No.: 12/370,292

(22) Filed: Feb. 12, 2009

Related U.S. Application Data
(60) Provisional application No. 61/027,913, filed on Feb. 12, 2008.

(51) Int. Cl. C08K 5/09

(52) U.S. Cl. 523/122; 264/328.1; 264/572; 264/103; 264/176.1

(57) ABSTRACT

A plastic material having an antimicrobial characteristic and the method for making the plastic material is provided. The method includes blending and/or extruding a polymeric composition in a process which includes a temperature of at least about 170° C. The method also includes adding an antimicrobial component to the polymeric composition prior to or during the blending and/or extruding. The antimicrobial component includes a salt of a dehydroacetic acid (DHA) in an amount sufficient to provide the resulting plastic material with an effective antimicrobial characteristic. The antimicrobial component including a salt of DHA is stable at temperatures required for processing polymeric compositions.

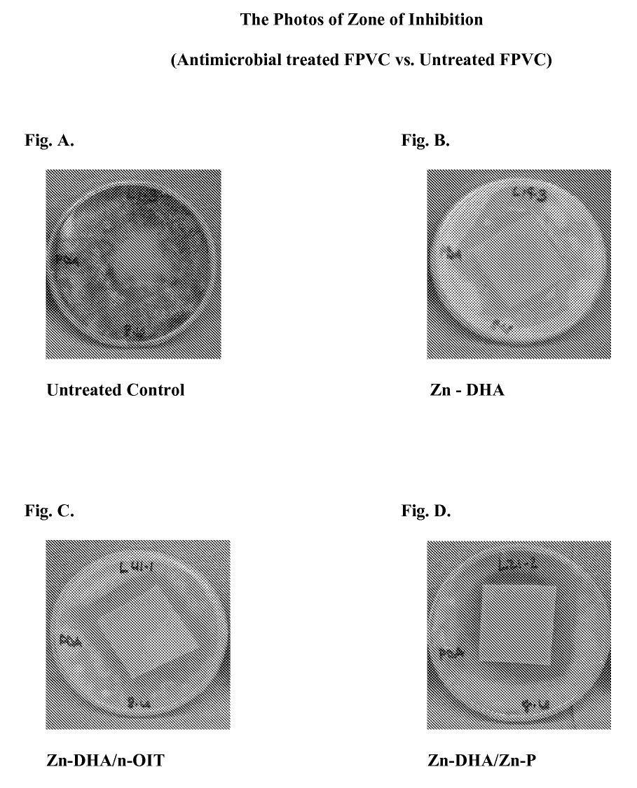

### BACKGROUND OF THE INVENTION

The present invention relates to plastics made of polymeric compositions and additives, and, in particular, to plastics which have an antimicrobial characteristic.

Modern plastic materials have been in use since the 1930s. Plastics are made of polymers and usually additives. Typical polymers include: synthetic resins, styrenes, polyolefins, polyamides, fluoropolymers, vinyls, acrylics, polyurethanes, cellulosics, imides, acetals, polycarbonates, and polysulfphones. Lacking nutrients required for microbial growth, most pure synthetic polymers have a natural resistance to microbes. However, in order to improve, among other things, physical characteristics of polymers, additives such as plasticizers are often used which serve as a source of nutrients for microorganisms.

Modern plasticizers include phthalates, adipates, and other esters. In the case of PVC, for example, the addition of plasticizers allows for production of clothing, upholstery, flexible hoses, tubing, flooring, roofing membranes, and electrical cable insulation.

Plasticizers are particularly susceptible to bacteria and fungi, especially in high moisture areas. Without the addition of antimicrobial agents, plastic materials experience microbial surface growth and development of spores. Microbial growth can result in allergic reactions, unpleasant odors, staining, embrittlement of the plastic, and premature product failure.

Thus, antimicrobials can be used to impart protection against mold, mildew, fungi and bacterial growth. Antimicrobials have been used in commercial products ranging from food to paint to plastic. Several antimicrobial formulations are used within the plastics industry. One of the major biocides used commercially is 10,10-oxybisphenoxarsine (OBPA) in a phthalate carrier. OBPA, an arsenic containing biocide, has been used in plastic resins, fibers, tapes, and other plastics. See U.S. Pat. No. 3,624,062 to Dunbar, and U.S. Pat. No. 4,086,297 to Rei, et al. And U.S. Pat. No. 4,663,077, to Rei, et al., also describes the use of OBPA to impart microbiocide properties to polymer compositions.

The use of OBPA has raised concerns regarding its environmental and human health impact. According to a Kline & Company study of the biocides industry in 2004 and 2005, the U.S. and European markets for biocides are very mature; however the EU's Biocidal Products Directive may convince consumers to reduce the role of OBPA as a biocide. If OBPA is banned, other antimicrobial products will be required to replace it.

There are certain other antimicrobial compounds in use. U.S. Pat. No. 3,755,224 to Lutz discloses a polymer containing the biocide 3-isothiazolones. For antimicrobial use in plastic, Minieri in U.S. Pat. 3,890,270 discloses N-(2,6-di-substituted-phenyl)maleimides. U.S. Pat. No. 6,495,613 to Gangus discloses an antimicrobial agent that releases silver, copper, zinc, or ions thereof, incorporated into dental plastics. The antimicrobial agent is preferably copper oxide or zinc silicate.

Dehydroacetic acid (DHA) has been used as a preservative for cosmetics and food products. It is approved by the FDA (21 CFR 172.130) as a food preservative and is a known antimicrobial, biocide and fungicide. U.S. Pat. No. 5,654,330, to Oppong, et al., discloses use of organic acids, and salts thereof, in combination with 2-bromo-4-hydroxyacteophenone (BHAP). However, the low boiling point of BHAP and its high toxicity, especially when inhaled, make it unsuitable for use at high temperatures, such as those required for processing polyvinyl, polyolefins, and polyurethanes. Therefore, the composition of Oppong, et al., is unsuitable for use in high temperature processes.

U.S. Pat. No. 4,348,308 to Minagawa, et al. also discloses using a salt of DHA in plastics as one component of an additive composition for improving the color stability of plastic. The composition disclosed by Minagawa, et al., contains an ortho-tertiary-alkyl substituted phenyl phosphite. According to Minagawa, et al., the ortho-tertiary-alkyl substituted phenyl phosphite reacts synergistically with the DHA compound.

U.S. Pat. No. 4,252,698 to Ito, et al. discloses an anti-yellowing composition for PVC wherein an overbased sulfonate or phenolate is combined with a cyclic or open-chained 1,3-diketone, or a metal salt thereof. Ito, et al. require the addition of a co-agent, specifically an overbased sulfonate or phenolate, to achieve anti-yellowing.

U.S. Pat. No. 5,147,917 to Sugawara, et al., discloses a halogen resin composition composed of an overbased alkaline earth metal carboylate/carbonate complex together with a β-diketone compound or a metal salt of a β-diketone. While DHA is listed as a β-diketone, the disclosure again requires a co-agent, in this case, an overbased alkaline earth metal carboxylate/carbonate.

Unfortunately, many antimicrobial compounds are not heat stable and degrade at the high temperatures required for molding of plastics. One reason the arsenic-containing antimicrobial OBPA is still one of the major biocides in plastics is its stability in the presence of heat in the range of processing flexible PVC, polyolefins and urethane compounds.

More environmentally-acceptable antimicrobial chemicals are desired to replace highly toxic material. For use in plastic, the antimicrobial should be stable at high temperatures. There are ongoing needs for effective antimicrobial protection, which also maintains surface appearance, prevents contamination, withstands the weathering of time, and extends the life of the plastic materials.

### SUMMARY OF THE INVENTION

The present invention is a plastic and a method for making the same, which includes a heat stable combination of at least one polymer, capable of forming a plastic, and a salt of dehydroacetic acid (DHA). The salt of DHA is present in the absence of a required co-agent and in an amount sufficient to provide antimicrobial properties to a plastic resulting therefrom.

The polymer, which is capable of forming a plastic, is selected from the group including: styrenes, polyolefins, polyamides, fluoropolymers, vinyls, acrylics, polyurethanes, cellulosics, imides, acetals, polycarbonates, polysulfones, polymeric resins, and combinations and co-polymers and inter-polymers thereof. The polymer is preferably a vinyl polymer and more preferably a polyvinyl chloride.

In another embodiment, the vinyl polymer is polyethylene, polypropylene, polybutadiene, polytetrafluoroethylene, polystyrene, polyacrylate, polymethacrylate, polyvinyl alcohol, polyvinyl acetate, polyvinyl chloride, or polyacrylonitrile.

The salt of DHA is a monovalent or divalent salt. It is preferably selected from the group including sodium, potassium, lithium, magnesium, zinc, copper, barium, calcium, strontium or tin and combinations thereof. Most preferably, the salt of DHA is a zinc salt.

The salt of DHA is present in an amount sufficient to provide antimicrobial properties to a plastic. Preferably the amount of a salt of DHA is from about 5 ppm to about 10,000 ppm, more preferably from about 50 ppm to about 8,500 ppm. The salt of DHA is most preferably present in an amount of from about 100 ppm to about 5,000 ppm. The ranges can also be any combination of the minimum and maximum amounts set forth above.

The ability to achieve antimicrobial properties while processing at elevated temperatures does not depend on a co-agent to be included with the DHA salt. No other chemical ingredient is required, and, in a preferred embodiment, additional chemical ingredient(s) used to augment, modify, enhance, or otherwise effect the salt of DHA, are not included.

The heat stable salt of DHA is stable at a temperature of at least about 170° C. and preferably from about 170° C. to 275° C.

The plastic can also contain a co-antimicrobial agent. The co-antimicrobial agent is preferably selected from the group consisting of Zn-pyrithione, isothiazolones, or tebuconozole (and combinations thereof). The co-antimicrobial agent is preferably present in an amount from about 5 ppm to about 10,000 ppm, more preferably from about 50 ppm to about 8,500 ppm. The co-antimicrobial agent is most preferably in an amount from about 100 ppm to about 5,000 ppm. The ranges can also be any combination of the minimum and maximum amounts set forth above.

The method can include polymer processing and then further processing. The processing (and further processing) is selected from: blending, extruding, fiber spinning, film blowing, filament winding, spin coating, molding, blow molding, injection molding, reaction injection molding, transfer molding, or a combination thereof.

The polymer processing (and further processing) can have a temperature profile which, for a significant portion of the processing, is not less than 170° C. Another preferred embodiment has a temperature profile which is predominantly over 170° C.

As a result of the present invention, the polymer can be used to make any product ranging from common building and domestic items to sterile laboratory equipment and medical instruments. The major applications include: flexible roofing membrane, pool liners, shower curtains, electrical appliances, food contact packaging, and automotive parts and accessories. The omission of arsenic containing antimicrobials reduces safety concerns.

The heat stability of a salt of DHA allows the compound to be added to the polymer prior to processing. By permeating the polymer with the salt of DHA, the antimicrobial nature can be maintained even, for example, if internal layers of the plastic become exposed to the environment via erosion of the outer layer, accidental puncture, or incidental wear and tear common due to the many rugged uses of plastics.

Furthermore, melding the salt of DHA with the polymer, can decrease the risk inherent in antimicrobial coatings, that of dissolution of the antimicrobial into the surrounding media.

Another advantage of the present invention is that salts of DHA could replace antimicrobials currently used in manufacturing of plastics, which rely on arsenic-containing antimicrobials. The omission of arsenic-containing antimicrobials can be better for the environment.

Since salts of DHA can be used at high temperatures in the absence of a co-agent, antimicrobial properties can be achieved in polymers that require high heat processing.

For a better understanding of the present invention, together with other and further objects, reference is made to the following description, taken in conjunction with the examples, and its scope will be pointed out in the appended claims.

### BRIEF DESCRIPTION OF THE DRAWINGS

FIG A is the untreated control for Example 2 Zone of Inhibition Test;

FIG B is the zinc dehydroacetic acid (Zn-DHA) result for Example 2 Zone of Inhibition Test;

FIG C is the Zn-DHA with octylisothiazolinone result for Example 2 Zone of Inhibition Test; and

FIG D is the Zn-DHA with zinc pyrithione result for Example 2 Zone of Inhibition Test.

### DETAILED DESCRIPTION OF THE INVENTION

The invention is a plastic and method of making the same, which includes combination of a heat stable salt of DHA and a polymer capable of forming a plastic. The plastic can be thermoplastic, thermoset, or elastomeric.

The polymer can be natural, synthetic, or semi-synthetic, and can, for example, be a polystyrene, polyolefin, polyamide, polyethylene, polypropylene, fluoropolymer, vinyl polymer, acrylic polymer, polyurethane, cellulosic, polyimide, polyacetal, polycarbonate, polysulfone, and all polymeric resins. The polymer can also be a combination of polymers, a copolymer, or an inter-polymer. The polymer is preferably a vinyl polymer, more preferably polyvinyl chloride. The polymer capable of forming a plastic also includes commercial forms of polymers provided to industry for further processing. This includes, for example, flexible polymers and polymer resins. The plastic is preferably a polyurethane, polyvinyl chloride, polyolefin, or polypropylene plastic. It is most preferably a polyvinyl chloride plastic.

The polymer capable of forming a plastic is preferably a vinyl polymer. The vinyl polymer can be a polyethylene, polypropylene, polybutadiene, polytetrafluoroethylene, polystyrene, polyacrylate, polymethacrylate, polyvinyl alcohol, polyvinyl acetate, polyvinyl chloride or polyacrylonitrile.

The plastic includes a heat stable salt of dehydroacetic acid. Dehydroactic acid (DHA) degrades only at high temperatures thereby permitting inclusion in processing of polyvinyl chloride, polyurethane and polyolefin plastics. Whereas DHA degrades at about 169° C., a heat stable salt of DHA remains stable at temperatures of at least about 170° C. and above. The present invention includes all heat stable salts of DHA. These salts are preferably monovalent or divalent salts. They can include, for example, sodium, potassium, lithium, magnesium, zinc, copper, barium, calcium, strontium, or tin and combinations thereof. The most preferable salt of the present invention is the zinc salt of DHA. The zinc salt of DHA, for example, is stable up to temperatures of about 275° C.

The salt of DHA provides antimicrobial properties to the plastic in the absence of a required co-agent. No other agent, especially a chemical agent (e.g., compound, composition, etc.), is required, and preferably, not present to co-act, modify, or otherwise effect the antimicrobial potential of the DHA salt. Antimicrobial properties include any biocidal, fungicidal, pesticidal, sporicidal and virucidal activity. The antimicrobial property can also, for example, include biostatic properties.

The salt of DHA is present in an amount sufficient to provide antimicrobial properties to a plastic resulting therefrom. Thus, a preferred embodiment of the invention would use about 5 ppm to abut 10,000 ppm of DHA salt, preferably from about 50 ppm to about 8,500 ppm, and more preferably from about 100 ppm to about 5,000 ppm. Any minimum and any maximum amount of DHA salt can be combined to form a suitable range.

The plastic can further comprise a co-antimicrobial agent. This co-antimicrobial agent can be any heat stable antimicrobial agent suitable for use in plastics. The co-antimicrobial agent can be any heat stable biostatic, biocidal, fungicidal, pesticidal, sporicidal or viricidal agent. A preferred embodiment of the invention would include Zn-pyrithione, isothiazolone, or tebuconazole. This embodiment of the invention would use at least about 5 ppm to about 10,000 ppm of co-antimicrobial agent, preferably from about 50 ppm to about 8,500 ppm, and more preferably from about 100 ppm to about 5,000 ppm. Suitable ranges of co-antimicrobial agent can be formed by combining any minimum and any maximum amount.

The invention also provides a method of providing a plastic with antimicrobial properties. This is achieved in the absence of a required co-agent, by combining at least one polymer with at least a heat stable salt of DHA. The salt of DHA is present in an amount sufficient to imbue the polymeric product with antimicrobial characteristics.

The method provides for polymer processing and further processing. The processing can be any type of processing to which a plastic can be subject. It can, for example, be blended, extruded, subjected to fiber spinning, film blowing, filament winding, or applied as a spin coating. It can also be molded in many ways, for example, such as blow molding, injection molding, reaction injection molding, or transfer molding.

The temperature profile for the polymer processing (and further processing) can include a temperature of not less than 170° C. The temperature profile can also be predominantly over 170° C.

The present invention can be better understood by reference to the following examples. The following examples illustrate the present invention and are not intended to limit the invention or its scope in any manner.

### EXAMPLES

### Antimicrobial Treated Plastic Sample Preparation for all Examples

The antimicrobial component containing salts of dehydroacetic acid, with or without additional antimicrobial components, were mixed with commercial flexible PVC (FPVC) compound. The mixtures were extruded on an intermeshing modular co-rotating twin screw extruder, and pelletized after cooling. The temperature profiles, from feed zone to die zone on the extruder are 140° C., 170° C., 175° C., 175° C., 175° C., and 175° C. The antimicrobial treated FPVC compounds were then cast on a press at 185° C. to form plastic sheets. Three 2″×2″ square samples were cut from each plastic sheet as test samples.

An untreated control sample of flexible PVC was manufactured without antimicrobial components.

### Example 1

### Fungal Resistance Test (ASTM G21)

A fungal inoculum was prepared. The fungal inoculum consisted of five species (test organisms): Aspergillus niger ATCC 9642, Aureobasidium pullulans ATCC 15233, Chaetomium globosum ATCC 6205, Penicillium funiculosum ATCC 11797, and Trichoderma virens ATCC 9645.

Test samples, in triplicate, were placed in Petri dishes on mineral salts agar and inoculated with the fungal inoculum. A Petri dish of mineral salts agar inoculated with the fungal inoculum served as the positive control. The untreated control was also inoculated. The samples were then incubated at 28° C. for 4 weeks and examined weekly for the growth of the test organisms.

For evaluation of relative resistance of synthetic polymeric materials, a rating scheme as set forth in footnote 1 of Table 1 was used:

TABLE 1
Fungal Resistance Test - ASTM G21 results

| | | Fungal | | |
|---|---|---|---|---|
| | | Growth | | |
| | Concen- | Reading¹ | | Formu- |
| | tration | (ASTM | Sample | lation |
| Controls | (ppm) | G21) | Number | Number |
| Positive Control | N/A | 4 | | |
| Untreated Control | 0 | 4 | NB 5794-109 A | UTC |
| | Concen- | Fungal | | Formu- |
| | tration | Growth | Sample | lation |
| Samples | (ppm) | Reading¹ | Number | Number |
| Zn-DHA | 2500 | 0 | NB 5794-109 S | S-12 |
| Zn-DHA/n-OIT | 1250/1250 | 0 | NB 5794-110 Q | S-15 |
| Zn-DHA/Zn—P | 1250/1250 | 0 | NB 5794-109 U | S-14 |
| Zn-DHA/ | 1250/1250 | 0 | NB 5794-109 V | S-17 |
| Tebuconazole | | | | |

| | |
|---|---|
| ¹Rating Scheme | |
| None | 0 |
| Traces of growth (less than 10%) | 1 |
| Light growth (10-30%) | 2 |
| Medium growth (30-60%) | 3 |
| Heavy growth (60% to complete coverage) | 4 |

### Example 1

### Fungal Resistance Discussion

The fungal resistance test results are listed in Table 1. While the Untreated Control showed maximum fungal growth (fungal growth rating of 4), Zn-DHA, and its blends: Zn-DHA/n-OIT (octylisothiazolinone), Zn-DHA/Zn-P (Zinc-Pyrithione), and Zn-DHA/Tebuconazole, demonstrate total fungal resistance (fungal growth rating of 0).

Consequently, flexible PVC without Zn-DHA (e.g., the “Untreated Control” of Example 1) is subject to fungi and other microbial attack. These fungi and other microbes can generate odors, cause pitting and discoloration, and lead to loss of mechanical properties. In contrast, the plastic of the invention (e.g., the “Samples” of Example 1), display total resistance to the fungal growth, avoiding such detrimental effects.

### Example 2

### Zone of Inhibition Test (Modified ASTM G21)

A fungal inoculum was prepared. The fungal inoculum consisted of five species (test organisms): Aspergillus niger ATCC 9642, Aureobasidium pullulans ATCC 15233, Chaetomium globosum ATCC 6205, Penicillium funiculosum ATCC 11797, and Trichoderma virens ATCC 9645.

Test samples, in triplicate, were placed in Petri dishes on Potato Dextrose Agar, and inoculated with the fungal inoculum. A positive control consisting of Potato Dextrose Agar and an untreated control consisting of untreated flexible PVC on Potato Dextrose Agar were also inoculated.

The samples and controls were incubated at 28° C. for 4 weeks and the Zone of Inhibition (ZOI) for each sample was examined. For evaluation of the ZOI a scheme as set forth in footnote 1 of Table 2 was used. Photos displaying the ZOI are contained in figures A through D.

### Zone of Inhibition Test Results

TABLE 2
Zone of Inhibition - Modified ASTM G21 results

| | | Zone of | | |
|---|---|---|---|---|
| | | Inhibition¹ | | |
| | Concen- | (Modified | | Formu- |
| | tration | ASTM | Sample | lation |
| Controls | (ppm) | G21) | Number | Number |
| Positive Control | N/A | − | | |
| Untreated | 0 | − | NB-5794-109 A | UTC |
| Control | | | | |
| | Concen- | Zone of | | Formu- |
| | tration | Inhibition¹ | Sample | lation |
| Samples | (ppm) | (ZOI) | Number | Number |
| Zn-DHA | 2500 | + | NB-5794-109 S | S-12 |
| Zn-DHA/n-OIT | 1250/1250 | ++ | NB-5794-110 Q | S-15 |
| Zn-DHA/Zn—P | 1250/1250 | ++ | NB-5794-109 U | S-14 |
| Zn-DHA/ | 1250/1250 | − | NB-5794-109 V | S-17 |
| Tebuconazole | | | | |

¹Zone of Inhibition Legend

| | |
|---|---|
| None | − |
| Small | + |
| Large | ++ |

### Example 2

### Zone of Inhibition Test Discussion

While the Untreated Control does not provide any Zone of Inhibition (ZOI), Zn-DHA treated flexible PVC provides a small ZOI, a blend of Zn-DHA and n-OIT and a blend of the Zn-DHA and Zn-P treated flexible PVC have a large ZOIs.

In contrast to the Fungal Resistance Test of Example 1, the Zone of Inhibition Test of Example 2 provides a range of results using various embodiments of the invention. Thus, while not shown in the drawings, the combination of Zn-DHA and Tebuconazole provided antimicrobial activity without registering a “+” ZOI around the plastic. Consequently, combinations within the parameters of the invention can be engineered and/or formulated to provide various unique efficacies, e.g., antimicrobial-on-plastic in combination with an antimicrobial-free zone thereabout.

Thus, while there have been described what are presently believed to be the preferred embodiments of the present invention, those skilled in the art will appreciate other and further changes and modifications thereto, and it is intended to include such other changes as come with the scope of the invention as set forth in the following claims.

1. A plastic comprising a combination of at least one polymer capable of forming a plastic and a heat stable salt of dehydroacetic acid (DHA) in an amount sufficient to provide an antimicrobial property to a plastic resulting therefrom in the absence of a required co-agent.

2. A plastic according to claim 1, wherein said polymer is selected from the group consisting of polystyrenes, polyolefins, polyamides, fluoropolymers, vinyl polymers, acrylic polymers, cellulosics, polyimides, polyacetals, polycarbonates, polysulfones, polymeric resins, and combinations and co-polymers and inter-polymers thereof.

3. A plastic according to claim 1, wherein said polymer is a vinyl polymer.

4. A plastic according to claim 3, wherein said vinyl polymer is polyvinyl chloride.

5. A plastic according to claim 1, wherein said salt of DHA is a salt of a divalent metal.

6. A plastic according to claim 1, wherein said salt of DHA is selected from the group consisting of sodium, potassium, lithium, magnesium, zinc, barium, calcium, copper, strontium, tin and combinations thereof.

7. A plastic according to claim 1, wherein said salt of DHA is zinc dehydroacetate.

8. A plastic according to claim 1, wherein said amount sufficient to provide antimicrobial properties to a plastic is from about 5 ppm to about 10,000 ppm.

9. A plastic according to claim 1, wherein said amount sufficient to provide antimicrobial properties to a plastic is from about 50 ppm to about 8,500 ppm.

10. A plastic according to claim 1, wherein said amount sufficient to provide antimicrobial properties to a plastic is from about 100 ppm to about 5,000 ppm.

11. A plastic according to claim 1, further comprising a co-antimicrobial agent.

12. A plastic according to claim 11, wherein said co-antimicrobial agent is selected from the group consisting of Zn-pyrithione, isothiazolones, tebuconazole and combinations thereof.

13. A plastic according to claim 11, wherein said co-antimicrobial agent antimicrobial agent is present in an amount from about 5 ppm to about 10,000 ppm.

14. A plastic according to claim 11, wherein said co-antimicrobial agent is present in an amount from about 50 ppm to about 8,500 ppm.

15. A plastic according to claim 11, wherein said co-antimicrobial agent is present in an amount from about 100 ppm to about 5,000 ppm.

16. A plastic according to claim 1, which experiences a heat profile during processing including a temperature of at least about 170° C. without destabilizing said salt of DHA.

17. A plastic according to claim 1, wherein said heat profile includes a temperature up to about 275° C. without destabilizing said salt of DHA.

18. A method of providing a thermoplastic product with an antimicrobial property, comprising, combining a polymer capable of forming a thermoplastic and a heat stable salt of dehydroacetic acid (DHA) in an amount sufficient to provide an antimicrobial property to a plastic resulting therefrom in the absence of a required co-agent.

19. A method according to claim 18, wherein said salt of DHA is a salt of a divalent metal.

20. A method according to claim 18, wherein said salt of DHA is selected from the group consisting of the DHA salts of sodium, potassium, lithium, magnesium, zinc, barium, calcium, copper, strontium, tin and combinations thereof.

21. A method according to claim 18, wherein said salt of DHA is zinc dehydroacetate.

22. A method according to claim 18, wherein the polymer is further combined with a co-antimicrobial agent.

23. A method according to claim 22, wherein said co-antimicrobial agent is selected from the group consisting of Zn-pyrithione, isothiazolones, tebuconazole and combinations thereof.

24. A method according to claim 22, wherein said co-antimicrobial agent antimicrobial agent is present in an amount from about 5 ppm to about 10,000 ppm.

25. A method according to claim 22, wherein said co-antimicrobial agent is present in an amount from about 50 ppm to about 8,500 ppm.

26. A method according to claim 22, wherein said co-antimicrobial agent is present in an amount from about 100 ppm to about 5,000 ppm.

27. A method according to claim 18, wherein said polymer is selected from the group consisting of polystyrenes, polyolefins, polyamides, fluoropolymers, vinyl polymers, acrylic polymers, polyacetals, polycarbonates, polysulfones, polymeric resins, and combinations and co-polymers and inter-polymers thereof.

28. A method according to claim 27, wherein said polymer is a vinyl polymer.

29. A method according to claim 28, wherein said vinyl polymer is polyvinyl chloride.

30. A method according to claim 18, wherein said effective amount of a salt of DHA is from about 5 ppm to about 10,000 ppm.

31. A method according to claim 18, wherein said effective amount of a salt of DHA is from about 50 ppm to about 8,500 ppm.

32. A method according to claim 18, wherein said effective amount of a salt of DHA is from about 100 ppm to about 5,000 ppm.

33. A method according to claim 18, further comprising polymer processing having a temperature profile predominantly over about 170° C.

34. A method according to claim 33, wherein said temperature profile includes a temperature of at least about 170° C.

35. A method according to claim 33, wherein said temperature profile is not less than 170° C.

36. A method according to claim 33, wherein said polymer processing is selected from the group consisting of blending, extruding, fiber spinning, film blowing, filament winding, spin coating, molding, blow molding, injection molding, reaction injection molding, transfer molding, and combinations thereof.

37. A method according to claim 33, wherein said polymer processing is followed by further processing.

38. A method according to claim 37, wherein said further processing is selected from the group consisting of blending, extruding, fiber spinning, film blowing, filament winding, spin coating, molding, blow molding, injection molding, reaction injection molding, transfer molding, and combinations thereof.

39. A method according to claim 33, wherein the polymer processing does not destabilize said salt of DHA.

40. A method according to claim 37, wherein the polymer processing does not destabilize said salt of DHA.

41. A method according to claim 39, wherein the polymer processing includes a temperature up to about 275° C. without destabilizing said salt of DHA.

42. A method according to claim 37, wherein said further processing has a temperature profile which includes a temperature of not less than 170° C.

43. A method according to claim 37, wherein said further processing has a temperature profile which includes at least 170° C.

44. A method according to claim 37, wherein said further processing has a temperature profile predominantly over 170° C.

45. A method according to claim 18, wherein said polymer is selected from the group consisting of polyamides, polyacetals, polycarbonates, polysulphones, and combinations and co-polymers, and inter-polymers thereof and co-polymers of cellulosic polymers.

46. A method according to claim 18, wherein said polymer is a vinyl polymer.

47. A method according to claim 46, wherein said vinyl polymer selected from the group consisting of polyethylene, polypropylene, polybutadiene, polytetrafluoroethylene, polystyrene, polyacrylate, polymethacrylate, polyvinyl alcohol, polyvinyl acetate, polyvinyl chloride, and polyacrylonitrile.

48. A method according to claim 18, wherein said polymer is a fluoropolymer.

49. A method according to claim 18, wherein said polymer is a polymeric resin.
